(19) United States
(12) Patent Application Publication
(10) Pub. No.: US 2024/0365338 A1
(43) Pub. Date: Oct. 31, 2024

(54) METHOD AND APPARATUS FOR TRANSMITTING DOWNLINK CONTROL INFORMATION (DCI)

(71) Applicant: BEIJING XIAOMI MOBILE SOFTWARE CO., LTD., Beijing (CN)

(72) Inventor: Qun ZHAO, Beijing (CN)

(21) Appl. No.: 18/682,835

(22) PCT Filed: Aug. 16, 2021
(86) PCT No.: PCT/CN2021/112872

§ 371 Date: Feb. 9, 2024

(51) Int. Cl. H04W 72/232; H04L 5/00; H04W 72/0453; H04W 72/30

(52) U.S. Cl. CPC H04W 72/232; H04L 5/0053; H04W 72/0453; H04W 72/30

(57) ABSTRACT

A method for transmitting downlink control information (DCI). The method includes: determining how to detect and receive DCI for scheduling a multi-broadcast scheduling (MBS) service based on a common frequency resource (CFR) configuration of a network device. Further, a communication apparatus is provided.

### CROSS-REFERENCE TO RELATED APPLICATION

This application is a U.S. national phase application of International Application No. PCT/CN2021/112872, filed on Aug. 16, 2021, the content of which is hereby incorporated by reference in its entirety.

### TECHNICAL FIELD

The present disclosure relates to a field of communication technology, and particularly to a method for transmitting downlink control information (DCI) and an apparatus transmitting DCI.

### BACKGROUND

In a wireless communication network, a terminal device receives a physical downlink control channel (PDCCH) through a dedicated bandwidth part (BWP) configured by a network device, and determines a type of a search space and other information and determines specific attributes of downlink control information (DCI) according to a configuration of a network device.

### SUMMARY

In a first aspect, embodiments of the disclosure provide a method for transmitting downlink control information (DCI). The method includes:
determining how to detect and receive DCI for scheduling a multi-broadcast scheduling (MBS) service based on a common frequency resource (CFR) configuration of a network device.

In a second aspect, embodiments of the disclosure provide a method for transmitting downlink control information (DCI). The method includes:
sending a common frequency resource (CFR) configuration to a terminal device; and
determine how to send DCI for scheduling a multi-broadcast scheduling (MBS) service based on the CFR configuration.

In a third aspect, embodiments of the disclosure provide a communication apparatus. The communication apparatus includes: a processor. When the processor calls computer programs stored in a memory, the method described in the first aspect is implemented.

In a fourth aspect, embodiments of the disclosure provide a communication apparatus. The communication apparatus includes: a processor. When the processor calls computer programs stored in a memory, the method described in the second aspect is implemented.

### BRIEF DESCRIPTION OF THE DRAWINGS

In order to clearly illustrate technical solutions of embodiments of the disclosure or background technologies, the accompanying drawings used in the embodiments or the background technologies will be explained below.

FIG. 1 is a schematic diagram of a communication system according to an embodiment of the disclosure.

FIG. 2 is a flowchart of a method for transmitting downlink control information (DCI) provided by an embodiment of the present disclosure.

FIG. 3 is a flowchart of a method for transmitting DCI provided by another embodiment of the present disclosure.

FIG. 4 is a flowchart of a method for transmitting DCI provided by another embodiment of the present disclosure.

FIG. 5 is a block diagram of a communication apparatus provided by an embodiment of the disclosure.

FIG. 6 is a block diagram of a communication apparatus provided by an embodiment of the disclosure.

FIG. 7 is a block diagram of a chip provided by an embodiment of the disclosure.

### DETAILED DESCRIPTION

In order to better understand the disclosure, terms involved in the disclosure are first described below.

### 1. Downlink Control Information (DCI)

The DCI is carried by a physical downlink control channel (PDCCH), and the DCI may include information on uplink and downlink resource allocation, hybrid automatic repeat request (HARQ), power control, and the like. The PDCCH is a physical channel used to carry downlink scheduling information.

### 2. Scrambling

Scrambling is a digital signal processing method, which may perform a XOR operation on an original signal with a scrambling code to obtain a new signal. Usually, the function of scrambling an uplink physical channel aims to distinguish different terminal devices, and downlink scrambling can distinguish cells and channels. The scrambling code can be used to scramble and descramble the original signal. For example, the scrambling code may scramble the DCI, or may be equivalent to scrambling the PDCCH. Scrambling the DCI may specifically refer to scrambling a cyclic redundancy check (CRC) field of the DCI. Correspondingly, the terminal device descrambles the received DCI, specifically, the terminal device descrambles the CRC field of the DCI using a corresponding type of scrambling code to determine a format or type of the DCI.

The scrambling code may include, but is not limited to: cell radio network temporary identifier (C-RNTI), temporary cell radio network temporary identifier (TC-RNTI), random access radio network temporary identifier (RA-RNTI), system information radio network temporary identifier (SI-RNTI), and paging radio network temporary identifier (P-RNTI).

### a) C-RNTI and TC-RNTI

If the terminal device is in a radio resource control connected (RRC-connected) state, it means that the terminal device has been assigned with a C-RNTI, and the terminal device needs to carry the C-RNTI when it initiates a random access request to a network device. If the terminal device is in an RRC idle state or an RRC inactive state, it means that the terminal device has not been assigned with a C-RNTI. If a terminal device requests a RRC connection, the network device may assign a temporary C-RNTI (which may be denoted as TC-RNTI) to the terminal device in subsequent response information. After the random access of the terminal device succeeds, the TC-RNTI can be converted into the C-RNTI.

### b) RA-RNTI

In a random access process, generation of the RA-RNTI is related to a time-frequency resource used by the terminal equipment to send a preamble. For example, when a terminal device A and a terminal device B use the same random access channel time-frequency resource to initiate the random access, the corresponding RA-RNTIs are the same.

### 3. Search Space (SS)

In the 5G NR system, due to a large system bandwidth and differences in demodulation capabilities of terminals, in order to improve resource utilization and reduce blind decoding (BD) complexity, the PDCCH no longer occupies the entire bandwidth in a frequency domain. At the same time, in order to increase system flexibility and adapt to different scenarios, a starting position of the PDCCH in a time domain can also be configured. Therefore, in the 5G NR, the UE needs to fully obtain time-frequency domain resource configuration information of the PDCCH before it can further demodulate the PDCCH. In the related art, information such as frequency domain resource information of the PDCCH and the number of orthogonal frequency division multiplexing (OFDM) symbols occupied by the PDCCH in the time domain is encapsulated in a control resource set (CORESET), and information such as a starting OFDM symbol of the PDCCH, a listening period and an associated CORESET is encapsulated in the search space.

The search spaces are classified into two types: common search space (CSS) and UE-specific search space (USS). The CSS is mainly used during access and cell switching, while USS is used after perform the access.

### 4. Multi-Broadcast Scheduling (MBS)

MBS is an important function of a wireless communication system defined by the IEEE802.16e protocol. MBS is explained in two situations: single base station access and multi-base station access. The single base station access refers to a multicast broadcast service in one base station, and the multi-base station access refers to that all terminals registered with the multicast broadcast content at the network level can receive the multicast broadcast services synchronously transmitted by all base stations in the multicast broadcast service area on downlink connections.

In order to better understand the method for transmitting downlink control information (DCI) provided in the embodiments of the disclosure, a communication system used in the embodiments of the disclosure is first described below.

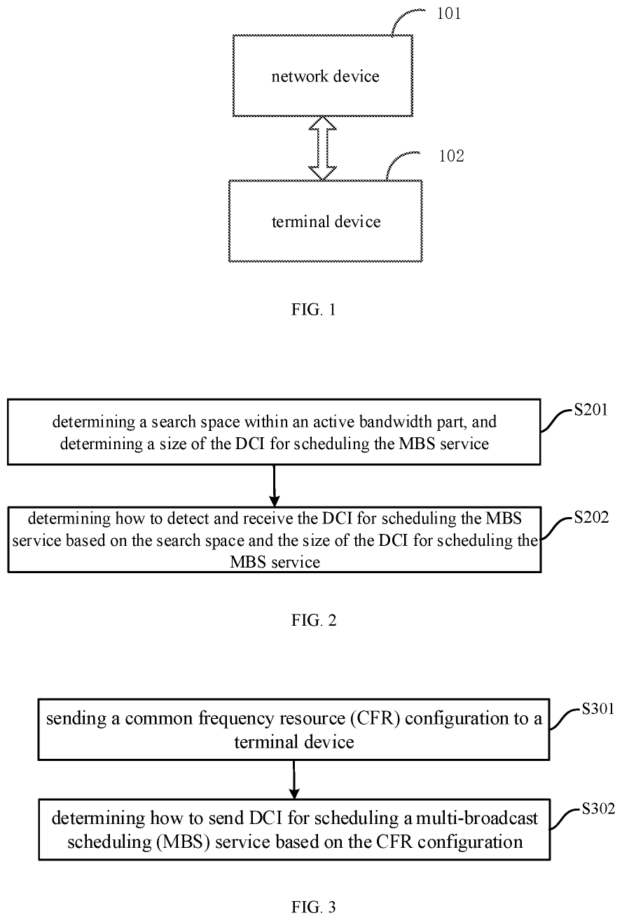

As illustrated in FIG. 1, FIG. 1 is a block diagram of a communication system provided by an embodiment of the disclosure. The communication system may include, but is not limited to, one network device, and one terminal device. The number and form of devices shown in FIG. 1 are only for examples and do not constitute a limitation on the embodiments of the disclosure, and the communication system may include two or more network devices, and two or more terminal devices in practical applications. The communication system shown in FIG. 1 includes, for example, one network device 101 and one terminal device 102.

It should be noted that the technical solutions of the embodiments of the disclosure can be used in various communication systems, such as, a long term evolution (LTE) system, a 5th generation (5G) mobile communication system, a 5G new radio (NR) system, or other future new mobile communication systems.

The network device 11 in the embodiments of the disclosure is an entity on a network side for transmitting or receiving signals. For example, the network device 101 may be an evolved NodeB (eNB), a transmission reception point (TRP), a next generation NodeB (gNB) in the NR system, a base station in other future mobile communication systems, or an access node in a wireless fidelity (WiFi) system. The specific technology and specific device form adopted by the network device are not limited in the embodiments of the disclosure. The network device provided by the embodiments of the disclosure may be composed of a central unit (CU) and a distributed unit (DU). The CU may also be called a control unit. The CU-DU structure allows a protocol layer of the network device, such as a base station, to be split, some functions of the protocol layer are placed in the CU for centralized control, and some or all of the remaining functions of the protocol layer are distributed in the DU, which is intensively controlled by the CU.

The terminal device 102 in the embodiments of the disclosure is an entity on a user side for receiving or transmitting signals, such as a cellular phone. The terminal device may also be referred to as a terminal, a user equipment (UE), a mobile station (MS), a mobile terminal (MT), and the like. The terminal device can be a car with a communication function, a smart car, a mobile phone, a wearable device, a Pad, a computer with a wireless transceiver function, a virtual reality (VR) terminal device, an augmented reality (AR) terminal device, a wireless terminal device in the industrial control, a wireless terminal device in the self-driving, a wireless terminal device in the remote medical surgery, a wireless terminal device in the smart grid, a wireless terminal device in the transportation safety, a wireless terminal device in the smart city, a wireless terminal device in the smart home, etc. The specific technology and specific device form adopted by the terminal device are not limited in the embodiments of the disclosure.

In the research of the Rel-17 MBS project, it is determined that if a common frequency resource (CFR) is configured, a corresponding configuration parameter needs to be configured for the CFR, for example, physical downlink shared channel configuration (PDSCH-config) is used to determine transmission parameters related to the transmitted PDSCH configured in the CFR, and PDCCH-config is used to determine transmission parameters related to the transmitted PDCCH configured in the CFR. However, when the network device does not configure the CFR for the terminal within the Bandwidth Part (BWP), regarding how to determine the relevant parameters of downlink transmission, especially how to determine a method for transmitting a downlink control channel, there is no corresponding method at present. Considering that the BWP is configured at the terminal level, there is no corresponding group-related configuration. If the BWP that is not configured with the CFR is also used for MBS transmission, the terminals in the group must have the same understanding of PDCCH transmission, such as PDCCH transmission resources, size of the DCI and so on.

For a terminal in a CONNECTED state, the network device configures a user equipment-specific (UE-specific) BWP for the terminal. The relevant configuration parameter of the BWP can only be known by the target terminal, and cannot be shared among terminals. The configuration parameter of the BWP includes a set of parameters related to downlink transmission, such as PDSCH-config and PDCCH-config. For example, the PDCCH-config is used to obtain a type of a search space used by the terminal to detect and receive the PDCCH in the BWP, a search space number, a related configuration of the CORESET, etc., and the terminal detects and receives the PDCCH in the BWP according to the related configuration of the PDCCH. At the same time, when detecting and receiving the PDCCH, the size of the DCI is determined according to factors such as the type of the search space, an active BWP or a size of an initial BWP, and the like.

It should be noted that the BWP configurations of different terminals may be different, and the BWP configurations are mutually isolated among terminals. That is, the terminal can only learn its own BWP configuration parameter, but cannot obtain BWP configuration parameters of other terminals.

When the network device transmits the MBS service on a BWP that is not configured with the CFR, since the current mechanism does not support the sharing of a UE-dedicated configuration among different terminals, the network device cannot know which search space is used to transmit the DCI, which PDCCH candidate in the search space is used to transmit the DCI, and which DCI alignment strategy is used to transmit the DCI. Correspondingly, the terminal device can only learn the relevant configuration parameter corresponding to the terminal. It is impossible to determine when and how to detect and receive the downlink control channel corresponding to the MBS.

In the related art, the relevant configuration parameter of the CFR includes necessary information required for PDCCH and PDSCH transmission. The terminals belonging to the same MBS group can learn how to detect and receive the PDCCH within the CFR according to the CFR parameter, and learn how to detect and receive the PDSCH according to scheduling information carried by the PDCCH. However, when the CFR is not configured in the BWP, there is no way to ensure that the network side and the terminal side have the same understanding of reception of the MBS PDCCH, so that the transmission of the MBS service cannot be successfully completed.

It is understood that the communication system described in the embodiments of the disclosure is intended to more clearly illustrate the technical solutions of the embodiments of the disclosure, and does not constitute a limitation on the technical solutions provided by the embodiments of the disclosure. It is understood by those skilled in the art that as the system architecture evolves and new business scenarios emerge, the technical solutions provided by the embodiments of the disclosure are also applicable to similar technical problems.

A method and apparatus for transmitting DCI will be introduced in detail below with reference to the accompanying drawings.

Embodiments of the disclosure provide a method for transmitting DCI, which is applied to a terminal device. The method includes:
determining how to detect and receive DCI for scheduling a multi-broadcast scheduling (MBS) service based on a common frequency resource (CFR) configuration of a network device.

In the embodiments of the disclosure, the terminal device receives the CFR configuration sent by the network device, and determines, based on the CFR configuration, a way of detecting and receiving the DCI for scheduling the MBS service (i.e., MBS-specific DCI).

In the embodiments of the disclosure, the terminal device receives the CFR configuration sent by the network device. If the CFR configuration is received by the terminal device, and the CFR configuration contains a CORESET or a search space, the terminal device detects and receives the DCI for scheduling the MBS service based on the CFR configuration.

If the CFR configuration is not received by the terminal device, or the CFR configuration is received by the terminal device and the CFR configuration does not contain a CORESET or a search space, it is required to determine a search space in an active BWP and a size of the DCI for scheduling the MBS service based on a predetermined mode, and to determine how to detect and receive the DCI for scheduling the MBS service based on the search space and the size of the DCI for scheduling the MBS service.

By implementing the embodiment of the disclosure, the method for receiving the DCI for scheduling the MBS service may be determined according to the CFR configuration. In this way, detection errors can be avoided and transmission efficiency can be improved.

Optionally, determining how to detect and receive the DCI for scheduling the MBS service based on the CFR configuration of the network device includes:
detecting and receiving the DCI for scheduling the MBS service based on the CFR configuration, in response to receiving the CFR configuration from the network device, and the CFR configuration including a control resource set (CORESET) or a search space.

In a possible implementation, the terminal device receives the CFR configuration sent by the network device, and the CFR configuration includes the CORESET or the search space, then the terminal device may learn how to detect and receive the DCI for scheduling the MBS service within the active BWP according to the CFR configuration, and learn how to detect and receive the PDSCH according to scheduling information carried by the DCI.

By implementing the embodiment of the disclosure, the method for receiving the DCI for scheduling the MBS service may be determined according to the CFR configuration. In this way, detection errors can be avoided and transmission efficiency can be improved.

Optionally, determining how to detect and receive the DCI for scheduling the MBS service based on the CFR configuration of the network device includes:
determining how to detect and receive the DCI for scheduling the MBS service based on a predetermined mode or a radio resource control (RRC) signaling, in response to not receiving the CFR configuration from the network device, or in response to receiving the CFR configuration from the network device but a CFR having no corresponding search space configuration, and a CORESET for a non-IBS data transmission being completely contained in the CFR configuration.

If the CFR configuration is not received by the terminal device, or the CFR configuration is received by the terminal device and the CFR configuration does not contain a CORESET or a search space, the terminal device may learn how to detect and receive the DCI for scheduling the MBS service within the active BWP according to the predetermined mode or the RRC signaling, and learn how to detect and receive the PDSCH according to scheduling information carried by the DCI.

In a possible implementation, the terminal devices UE #1, UE #2, . . . UE #M all support the MBS service, and belong to the same MBS group. The network device does not configure the CFR for the active BWP of all or some of the terminals in the MBS group, and the active BWP of the UE #1 has no relevant CFR configuration. Then, it is required to determine how UE #1 detects and receives the DCI for scheduling the MBS service according to the predetermined mode or the RRC signaling.

By implementing the embodiment of the disclosure, how to detect and receive the DCI for scheduling the MBS service and a method for receiving the DCI for scheduling the MBS service may be determined according to the predetermined mode or the RRC signaling. In this way, detection errors can be avoided and transmission efficiency can be improved.

As illustrated in FIG. 2, FIG. 2 is a flowchart of a method for transmitting DCI provided by an embodiment of the disclosure. The method is performed by a terminal device. As illustrated in FIG. 2, the method includes, but is not limited to the following steps.

At step S201, a search space within an active bandwidth part is determined, and a size of the DCI for scheduling the MBS service is determined.

If the CFR configuration is not received by the terminal device, or the CFR configuration is received by the terminal device and the CFR configuration does not contain a CORESET or a search space, the search space within the active BWP is determined and the size of the DCI for scheduling the MBS service is determined based on the predetermined mode or the RRC signaling.

At step S202, how to detect and receive the DCI for scheduling the MBS service is determined based on the search space and the size of the DCI for scheduling the MBS service.

After determining the search space within the active BWP and the size of the DCI for scheduling the MBS service, the terminal device can search for a DCI with the size of the DCI for scheduling the MBS service in the search space to obtain the DCI for scheduling the MBS service, and learn how to detect and receive the PDSCH according to the scheduling information carried by the DCI.

By implementing the embodiment of the disclosure, the search space within the active BWP and the size of the DCI for scheduling the MBS service may be determined according to the predetermined mode, and detection and reception of the DCI for scheduling the MBS service and a method for receiving the DCI for scheduling the MBS service may be further determined. In this way, detection errors can be avoided and transmission efficiency can be improved.

Optionally, determining the search space within the active bandwidth part includes:
in response to the network device configuring an MBS terminal group, determining the search space based on a common search space (CSS) configured in a bandwidth part.

If the network device configures an MBS terminal group, and the terminal device belongs to the MBS terminal group, the DCI for scheduling the MBS service may be transmitted using the CSS configured in the BWP.

In a possible implementation, the active BWP is not configured with the CFR, the base station uses the CSS on the active BWP to transmit MBS-specific DCI for scheduling the MBS service. Further, a type and a serial number of the CSS for transmitting the MBS-specific DCI for scheduling the MBS service are determined through the predetermined mode. The type of the CSS may be any one of Type0-PDCCH CSS, Type0a-PDCCH CSS, Type1-PDCCH CSS, Type2-PDCCH CSS, and Type3-PDCCH CSS.

Optionally, determining the search space based on the CSS configured in the bandwidth part includes:
determining a CSS with a predefined serial number as the search space.

The CSS has a corresponding serial number (also called index), and the search space in the CSS can be determined according to the predefined serial number, and the predefined serial number is preset. The implementer can adjust the predefined serial number according to the actual situation.

By implementing the embodiment of the disclosure, the search space within the active BWP can be determined according to the predetermined mode, and detection and reception of the DCI for scheduling the MBS service and the method for receiving the DCI for scheduling the MBS service can be further determined. In this way, detection errors can be avoided and transmission efficiency can be improved.

Optionally, determining the CSS with the predefined serial number as the search space includes at least one of:
determining the search space based on a highest serial number of the CSS; or
determining the search space based on a lowest serial number of the CSS.

In a possible implementation, the predefined serial number is the highest serial number in the CSS.

In another possible implementation, the predefined serial number is the lowest serial number in the CSS.

In a possible implementation, the terminal UE #1 and the network side determine to detect, receive and send the DCI for scheduling the MBS service in the CSS based on a predetermined way. The type of the CSS used to transmit the MBS-specific DCI is Type3-PDCCH CSS. When there are multiple Type3-PDCCH CSSs in the BWP, it is determined that the CSS with the lowest CSS index is used to transmit the MBS-specific DCI.

By implementing the embodiment of the disclosure, the search space within the active BWP can be determined according to the predetermined mode, and detection and reception of the DCI for scheduling the MBS service and the method for receiving the DCI for scheduling the MBS service can be further determined. In this way, detection errors can be avoided and transmission efficiency can be improved.

Optionally, determining the search space within the active bandwidth part further includes:
in response to the network device configuring an MBS terminal group, determining the search space based on a UE-specific search space (USS) configured in a bandwidth part.

If the network device configures the MBS terminal group and the terminal device belongs to the MBS terminal group, the DCI for scheduling the MBS service may be transmitted using the USS configured in the BWP.

In a possible implementation, the active BWP is not configured with the CFR, the base station uses the USS on the active BWP to transmit MBS-specific DCI for scheduling the MBS service. Further, a serial number of the USS for transmitting the MBS-specific DCI for scheduling the MBS service is determined through the predetermined mode.

Optionally, determining the search space based on the USS configured in the bandwidth part includes:
determining a USS with a predefined serial number as the search space.

The USS has a corresponding serial number, and the search space in the USS can be determined according to the predefined serial number, and the predefined serial number is preset. The implementer can adjust the predefined serial number according to the actual situation.

By implementing the embodiment of the disclosure, the search space within the active BWP can be determined according to the predetermined mode, and detection and reception of the DCI for scheduling the MBS service and the method for receiving the DCI for scheduling the MBS service can be further determined. In this way, detection errors can be avoided and transmission efficiency can be improved.

Optionally, determining the USS with the predefined serial number as the search space includes at least one of:
determining the search space based on a highest serial number of the USS; or
determining the search space based on a lowest serial number of the USS.

In a possible implementation, the terminal UE #1 and the network side determine to detect, receive and send the DCI for scheduling the MBS service in the USS based on a predetermined way. When there are multiple USSs in the BWP, it is determined that the USS with the lowest USS index is used to transmit the MBS-specific DCI.

By implementing the embodiment of the disclosure, the search space within the active BWP can be determined according to the predetermined mode, and detection and reception of the DCI for scheduling the MBS service and the method for receiving the DCI for scheduling the MBS service can be further determined. In this way, detection errors can be avoided and transmission efficiency can be improved.

Optionally, determining how to detect and receive the DCI for scheduling the MBS service based on the RRC signaling includes:
determining the search space within the active bandwidth part based on a search space number in the RRC signaling.

The RRC signaling may carry the search space number, and the search space within the active BWP may be determined according to the search space number.

In a possible implementation, when determining the CSS for transmitting the MBS-specific DCI on the active BWP of UE #1, the base station indicates the type and the serial number of the CSS adopted by the terminal through the RRC signaling.

In a possible implementation, when determining the USS for transmitting the MBS-specific DCI on the active BWP of UE #1, the base station indicates the serial number of the USS used by the terminal through the RRC signaling.

By implementing the embodiment of the disclosure, the search space within the active BWP can be determined according to the RRC signaling, and detection and reception of the DCI for scheduling the MBS service and the method for receiving the DCI for scheduling the MBS service can be further determined. In this way, detection errors can be avoided and transmission efficiency can be improved.

Optionally, determining the size of the DCI for scheduling the MBS service includes:
in response to the DCI for scheduling the MBS service being transmitted in a corresponding CSS, and the CSS being of Type 0/0a/1/2, determining the size of the DCI for scheduling the MBS service as a size of payload of a first DCI format in the CSS;
in which, the first DCI format comprises at least one of: DCI format 1_0 scrambled with a system information radio network temporary identifier (SI-RNTI), DCI format 1_0 scrambled with a random access radio network temporary identifier (RA-RNTI), DCI format 1_0 scrambled with a temporary cell radio network temporary identifier (TC-RNTI), and DCI format 1_0 scrambled with a paging radio network temporary identifier (P-RNTI).

By implementing the embodiment of the disclosure, the size of the DCI for scheduling the MBS service can be determined according to the predetermined mode, and detection and reception of the DCI for scheduling the MBS service and the method for receiving the DCI for scheduling the MBS service can be further determined. In this way, detection errors can be avoided and transmission efficiency can be improved.

In a possible implementation, the type of the CSS used to transmit the MBS-specific DCI is Type0-PDCCH CSS, the terminal UE #1 and the network side perform an alignment operation on the MBS-specific DCI transmitted in the active BWP and other DCIs transmitted in the corresponding CSS, so that the sizes of the other DCIs transmitted in the CSS used to transmit the MBS-specific DCI are the same, which may be implemented according to the method described below. The specific implementation of the alignment operation is not limited in the disclosure. Considering that the DCI for scheduling MBS service is transmitted in the Type 0 PDCCH CSS, the payload size of the DCI is consistent with the size of any of the DCI format 1_0 scrambled with the SI-RNTI, the DCI format 1_0 scrambled with the RA-RNTI, the DCI format 1_0 scrambled with the TC-RNTI, and the DCI format 1_0 scrambled with the P-RNTI transmitted in the search space.

The size of the DCI for scheduling the MBS service is determined based on the type of the CSS.

Optionally, determining the size of the DCI for scheduling the MBS service further includes:
in response to the DCI for scheduling the MBS service being transmitted in a corresponding CSS, and the CSS being of Type 3, determining the size of the DCI for scheduling the MBS service as a size of payload of a second DCI format in the CSS;
in which, the second DCI format comprises at least one of: DCI format 20, DCI format 2_1, DCI format 2_2, DCI format 2_3, DCI format 2_4, DCI format 2_5, DCI format 2_6.

In a possible implementation, the type of the CSS used to transmit the MBS-specific DCI is Type3-PDCCH CSS, the terminal UE #1 and the network side perform an alignment operation on the MBS-specific DCI transmitted in the active BWP and other DCIs transmitted in the corresponding CSS, so that the sizes of the other DCIs transmitted in the CSS used to transmit the MBS-specific DCI are the same, which may be implemented according to the method described below. The specific implementation of the alignment operation is not limited in the disclosure. Considering that the DCI for scheduling the IBS service is transmitted in the Type 3 PDCCH CSS, the payload size of the DCI is consistent with the size of the DCI format 2_0, the DCI format 2_1, the DCI format 2_2, the DCI format 2_3, the DCI format 2_4, the DCI format 2_5 or the DCI format 2_6 transmitted in the search space.

By implementing the embodiment of the disclosure, the size of the DCI for scheduling the MBS service can be determined according to the predetermined mode, and detection and reception of the DCI for scheduling the IBS service and the method for receiving the DCI for scheduling the IBS service can be further determined. In this way, detection errors can be avoided and transmission efficiency can be improved.

Optionally, determining the size of the DCI for scheduling the MBS service further includes:

in response to the DCI for scheduling the MBS service being transmitted in a USS, determining the size of the DCI for scheduling the MBS service as a size of payload of DCI format 1_1 and/or DCI format 1_2 in the CSS.

In a possible implementation, the USS is used to transmit the MBS-specific DCI, the terminal UE #1 and the network side perform an alignment operation on the MBS-specific DCI transmitted in the active BWP and other DCIs transmitted in the corresponding USS, so that the sizes of the other DCIs transmitted in the USS used to transmit the IBS-specific DCI are the same, which may be implemented according to the method described below. The specific implementation of the alignment operation is not limited in the disclosure. Considering that the DCI for scheduling the MBS service is transmitted in the USS, the payload size of the DCI is consistent with the size of the DCI format 1_1 and/or the DCI format 1_2 transmitted in the search space.

By implementing the embodiment of the disclosure, the size of the DCI for scheduling the MBS service can be determined according to the predetermined mode, and detection and reception of the DCI for scheduling the MBS service and the method for receiving the DCI for scheduling the MBS service can be further determined. In this way, detection errors can be avoided and transmission efficiency can be improved.

Optionally, determining how to detect and receive the DCI for scheduling the MBS service based on the search space and the size of the DCI for scheduling the MBS service includes:
determining one or more physical downlink control channel (PDCCH) candidates within in a CSS in the active bandwidth part based on the size of the DCI for scheduling the MBS service, detecting and receiving the DCI for scheduling the MBS service on all of the one or more PDCCH candidates contained in the CSS; or
determining one or more PDCCH candidates within in a CSS in the active bandwidth part based on the size of the DCI for scheduling the MBS service, detecting and receiving the DCI for scheduling the MBS service on a portion of the one or more PDCCH candidates contained in the CSS.

In the embodiment of the disclosure, after obtaining the search space and the size of the DCI for scheduling the MBS service, the PDCCH candidates can be determined in the search space, the DCI for scheduling the MBS service is detected and received among all the PDCCH candidates according to the size of the DCI for scheduling the MBS service, and the search space is the CSS.

After obtaining the search space and the size of the DCI for scheduling the MBS service, the PDCCH candidates can be determined in the search space, the DCI for scheduling the MBS service is detected and received among some of the PDCCH candidates according to the size of the DCI for scheduling the MBS service, and the search space is the CSS.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. An attempt of detection and reception of the MBS-specific DCI is performed on all the PDCCH candidates included in the CSS, and the CRC of the MBS-specific DCI is scrambled with a Group scheduling Radio Network Temporary Identifier (G-RNTI).

By implementing the embodiment of the disclosure, how to detect and receive the DCI for scheduling the MBS service can be determined according to the PDCCH candidate, the search space, and the size of the DCI for scheduling the MBS service. In this way, detection errors can be avoided and transmission efficiency can be improved.

Optionally, detecting and receiving the DCI for scheduling the MBS service on the portion of the one or more PDCCH candidates contained in the CSS includes:
detecting and receiving the DCI for scheduling the MBS service on N predefined PDCCH candidates, where N is a positive integer; or
detecting and receiving the DCI for scheduling the MBS service on a PDCCH candidate configured and indicated by the RRC signaling.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. N PDCCH candidates are selected from the PDCCH candidates included in the CSS, an attempt of detection and reception of the MBS-specific DCI is performed on the N PDCCH candidates, and the CRC of the MBS-specific DCI is scrambled with the G-RNTI.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. Some PDCCH candidates of the PDCCH candidates included in the CSS are obtained based on configuration of the RRC signaling, an attempt of detection and reception of the MBS-specific DCI is performed on the some PDCCH candidates, and the CRC of the MBS-specific DCI is scrambled with the G-RNTI.

By implementing the embodiment of the disclosure, how to detect and receive the DCI for scheduling the MBS service can be determined according to the PDCCH candidate predefined or indicated by the RRC signaling, the search space, and the size of the DCI for scheduling the MBS service. In this way, detection errors can be avoided and transmission efficiency can be improved.

Optionally, determining how to detect and receive the DCI for scheduling the MBS service based on the search space and the size of the DCI for scheduling the MBS service includes:
determining one or more PDCCH candidates within in a USS in the active bandwidth part based on the size of the DCI for scheduling the MBS service, detecting and receiving the DCI for scheduling the MBS service on all of the one or more PDCCH candidates contained in the USS; or
determining one or more PDCCH candidates within in a USS in the active bandwidth part based on the size of the DCI for scheduling the MBS service, detecting and receiving the DCI for scheduling the MBS service on a portion of the one or more PDCCH candidates contained in the USS.

In the embodiment of the disclosure, the USS is used to transmit the MBS-specific DCI, and after the search space corresponding to the active BWP is determined, the DCI for scheduling the MBS service is transmitted in the search space according to a payload size (DCIpayload size) of the corresponding DCI. N PDCCH candidates are selected from the PDCCH candidates included in the USS, an attempt of detection and reception of the MBS-specific DCI is performed on the N PDCCH candidates, and the CRC of the MBS-specific DCI is scrambled with the G-RNTI.

In a possible implementation, the USS is used to transmit the MBS-specific DCI, and after the search space corresponding to the active BWP is determined, the DCI for scheduling the MBS service is transmitted in the search space according to a payload size (DCIpayload size) of the corresponding DCI. Some PDCCH candidates of the PDCCH candidates included in the USS are obtained based on configuration of the RRC signaling, an attempt of detection and reception of the MBS-specific DCI is performed on the some PDCCH candidates, and the CRC of the MBS-specific DCI is scrambled with the G-RNTI.

By implementing the embodiment of the disclosure, how to detect and receive the DCI for scheduling the MBS service can be determined according to the PDCCH candidate, the search space, and the size of the DCI for scheduling the MBS service. In this way, detection errors can be avoided and transmission efficiency can be improved.

Optionally, detecting and receiving the DCI for scheduling the MBS service on the portion of the one or more PDCCH candidates contained in the USS includes:
detecting and receiving the DCI for scheduling the MBS service on N predefined PDCCH candidates, where N is a positive integer; or
detecting and receiving the DCI for scheduling the MBS service on a PDCCH candidate configured and indicated by the RRC signaling.

In a possible implementation, a positive integer N is predefined, and the DCI for scheduling the MBS service is detected and received on the N PDCCH candidates.

In a possible implementation, a corresponding PDCCH candidate is obtained according to configuration and indication of the RRC signaling, and the DCI for scheduling the MBS service is detected and received on the PDCCH candidate indicated by the RRC signaling.

By implementing the embodiment of the disclosure, how to detect and receive the DCI for scheduling the MBS service can be determined according to the PDCCH candidate predefined or indicated by the RRC signaling, the search space, and the size of the DCI for scheduling the MBS service. In this way, detection errors can be avoided and transmission efficiency can be improved.

As illustrated in FIG. 3, FIG. 3 is a flowchart of a method for transmitting DCI provided by an embodiment of the disclosure. The method is performed by a network device. As illustrated in FIG. 3, the method includes, but is not limited to the following steps.

At step S301, a CFR configuration is sent to a terminal device.

In the embodiment of the disclosure, the CFR configuration sent by the network device is configured for the terminal device, and a way of sending the DCI for scheduling the MBS service (i.e., MBS-specific DCI) is determined based on the CFR configuration.

At step S302, how to send the DCI for scheduling the MBS service is determined based on the CFR configuration.

In the embodiment of the disclosure, the terminal device receives the CFR configuration sent by the network device. If the network device configures the CFR, and the CFR configuration contains a CORESET or a search space, the network device sends the DCI for scheduling the MBS service based on the CFR configuration.

If the network device does not configure the CFR for the terminal device, or the network device configures the CFR for the terminal device and the CFR configuration does not contain a CORESET or a search space, it is required to determine a search space in an active BWP and a size of the DCI for scheduling the MBS service based on a predetermined mode, and to determine how to send the DCI for scheduling the MBS service based on the search space and the size of the DCI for scheduling the MBS service.

By implementing the embodiment of the disclosure, the method for sending the DCI for scheduling the MBS service may be determined according to the CFR configuration. In this way, detection errors can be avoided and transmission efficiency can be improved.

Optionally, determining how to send the DCI for scheduling the MBS service based on the CFR configuration includes:
sending the DCI for scheduling the MBS service based on the CFR configuration, in response to the CFR configuration including a control resource set (CORESET) or a search space.

In a possible implementation, the network device sends the CFR configuration, and the CFR configuration includes the CORESET or the search space, then the network device may learn how to send the DCI for scheduling the MBS service within the active BWP according to the CFR configuration, and learn how to send the PDSCH according to scheduling information carried by the DCI.

Optionally, determining how to send the DCI for scheduling the MBS service based on the CFR configuration includes:
determining how to send the DCI for scheduling the MBS service based on a predetermined mode or a radio resource control (RRC) signaling, in response to not sending the CFR configuration, or in response to a CFR having no corresponding search space configuration, and a CORESET for a non-MBS data transmission being completely contained in the CFR configuration.

If the CFR configuration is not sent by the network device, or the CFR configuration is sent by the network device and the sent CFR configuration does not contain a CORESET or a search space, the network device may learn how to send the DCI for scheduling the MBS service within the active BWP according to the predetermined mode or the RRC signaling, and learn how to send the PDSCH according to scheduling information carried by the DCI.

In a possible implementation, the terminal devices UE #1, UE #2, . . . UE #M all support the MBS service, and belong to the same MBS group. The network device does not configure the CFR for the active BWP of all or some of the terminals in the MBS group, and the active BWP of the UE #1 has no relevant CFR configuration. Then, it is required to determine how the network device sends the DCI for scheduling the MBS service according to the predetermined mode or the RRC signaling.

By implementing the embodiment of the disclosure, how to send the DCI for scheduling the MBS service may be determined according to the predetermined mode or the RRC signaling. In this way, detection errors can be avoided and transmission efficiency can be improved.

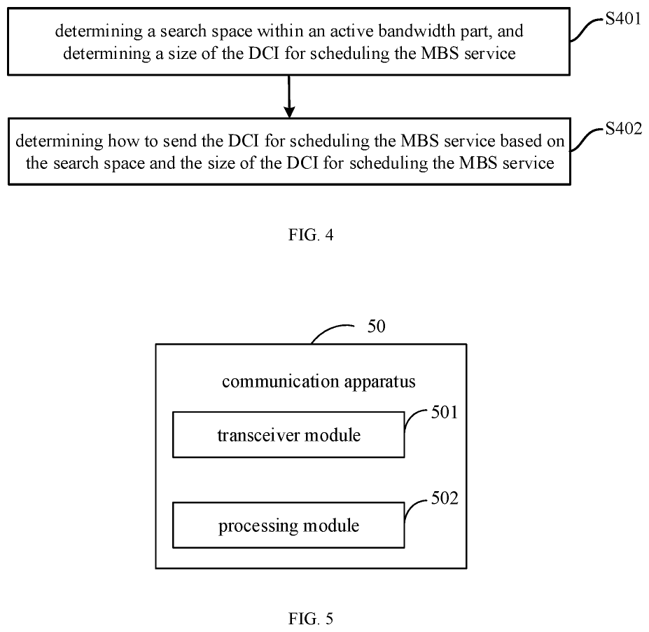

As illustrated in FIG. 4, FIG. 4 is a flowchart of a method for transmitting DCI provided by an embodiment of the disclosure. The method is performed by a network device. As illustrated in FIG. 4, the method includes, but is not limited to the following steps.

At step S401, a search space within an active bandwidth part is determined, and a size of the DCI for scheduling the MBS service is determined.

If the CFR configuration is not sent by the network device, or the CFR configuration is sent by the network device and the CFR configuration does not contain a CORESET or a search space, the search space within the active BWP is determined and the size of the DCI for scheduling the MBS service is determined based on the predetermined mode or the RRC signaling.

At step S402, how to send the DCI for scheduling the MBS service is determined based on the search space and the size of the DCI for scheduling the MBS service.

After determining the search space within the active BWP and the size of the DCI for scheduling the MBS service, the network device can search for a DCI with the size of the DCI for scheduling the MBS service in the search space to obtain the DCI for scheduling the MBS service, and learn how to send the PDSCH according to the scheduling information carried by the DCI.

Optionally, determining the search space within the active bandwidth part includes:
in response to configuring an MBS terminal group and the terminal device belonging to the MBS terminal group, determining the search space based on a common search space (CSS) configured in a bandwidth part.

If the network device configures an MBS terminal group, and the terminal device belongs to the MBS terminal group, the DCI for scheduling the MBS service may be transmitted using the CSS configured in the BWP.

In a possible implementation, the active BWP is not configured with the CFR, the base station uses the CSS on the active BWP to transmit MBS-specific DCI for scheduling the MBS service. Further, a type and a serial number of the CSS for transmitting the MBS-specific DCI for scheduling the MBS service are determined through the predetermined mode. The type of the CSS may be any one of Type0-PDCCH CSS, Type0a-PDCCH CSS, Type1-PDCCH CSS, Type2-PDCCH CSS, and Type3-PDCCH CSS.

Optionally, determining the search space based on the CSS configured in the bandwidth part includes:
determining a CSS with a predefined serial number as the search space.

The CSS has a corresponding serial number (also called index), and the search space in the CSS can be determined according to the predefined serial number, and the predefined serial number is preset. The implementer can adjust the predefined serial number according to the actual situation.

Optionally, determining the CSS with the predefined serial number as the search space includes at least one of:
determining the search space based on a highest serial number of the CSS; or
determining the search space based on a lowest serial number of the CSS.

In a possible implementation, the predefined serial number is the highest serial number in the CSS.

In another possible implementation, the predefined serial number is the lowest serial number in the CSS.

In a possible implementation, the terminal UE #1 and the network side determine to send the DCI for scheduling the MBS service in the CSS based on a predetermined way. The type of the CSS used to transmit the MBS-specific DCI is Type3-PDCCH CSS. When there are multiple Type3-PDCCH CSSs in the BWP, it is determined that the CSS with the lowest CSS index is used to transmit the MBS-specific DCI.

Optionally, determining the search space within the active bandwidth part further includes:
in response to the network device configuring an MBS terminal group, determining the search space based on a UE-specific search space (USS) configured in a bandwidth part.

If the network device configures the MBS terminal group and the terminal device belongs to the MBS terminal group, the DCI for scheduling the MBS service may be transmitted using the USS configured in the BWP.

In a possible implementation, the active BWP is not configured with the CFR, the base station uses the USS on the active BWP to transmit MBS-specific DCI for scheduling the MBS service. Further, a serial number of the USS for transmitting the MBS-specific DCI for scheduling the MBS service is determined through the predetermined mode.

Optionally, determining the search space based on the USS configured in the bandwidth part includes:
determining a USS with a predefined serial number as the search space.

The USS has a corresponding serial number, and the search space in the USS can be determined according to the predefined serial number, and the predefined serial number is preset. The implementer can adjust the predefined serial number according to the actual situation.

Optionally, determining the USS with the predefined serial number as the search space includes at least one of:
determining the search space based on a highest serial number of the USS; or
determining the search space based on a lowest serial number of the USS.

In a possible implementation, the terminal UE #1 and the network side determine to send the DCI for scheduling the MBS service in the USS based on a predetermined way. When there are multiple USSs in the BWP, it is determined that the USS with the lowest USS index is used to transmit the MBS-specific DCI.

Optionally, determining how to send the DCI for scheduling the MBS service based on the RRC signaling includes:
determining the search space within the active bandwidth part based on a search space number in the RRC signaling.

The RRC signaling may carry the search space number, and the search space within the active BWP may be determined according to the search space number.

In a possible implementation, when determining the CSS for transmitting the MBS-specific DCI on the active BWP of UE #1, the base station indicates the type and the serial number of the CSS adopted by the terminal through the RRC signaling.

In a possible implementation, when determining the USS for transmitting the MBS-specific DCI on the active BWP of UE #1, the base station indicates the serial number of the USS used by the terminal through the RRC signaling.

Optionally, determining the size of the DCI for scheduling the MBS service includes:
in response to the DCI for scheduling the MBS service being transmitted in a corresponding CSS, and the CSS being of Type 0/0a/1/2, determining the size of the DCI for scheduling the MBS service as a size of payload of a first DCI format in the CSS;
in which, the first DCI format comprises at least one of: DCI format 1_0 scrambled with a system information radio network temporary identifier (SI-RNTI), DCI format 1_0 scrambled with a random access radio network temporary identifier (RA-RNTI), DCI format 1_0 scrambled with a temporary cell radio network temporary identifier (TC-RNTI), and DCI format 1_0 scrambled with a paging radio network temporary identifier (P-RNTI).

In a possible implementation, the type of the CSS used to transmit the MBS-specific DCI is Type0-PDCCH CSS, the terminal UE #1 and the network side perform an alignment operation on the MBS-specific DCI transmitted in the active BWP and other DCIs transmitted in the corresponding CSS, so that the sizes of the other DCIs transmitted in the CSS used to transmit the MBS-specific DCI are the same, which may be implemented according to the method described below. The specific implementation of the alignment operation is not limited in the disclosure. Considering that the DCI for scheduling MBS service is transmitted in the Type 0 PDCCH CSS, the payload size of the DCI is consistent with the size of any of the DCI format 1_0 scrambled with the SI-RNTI, the DCI format 1_0 scrambled with the RA-RNTI, the DCI format 1_0 scrambled with the TC-RNTI, and the DCI format 1_0 scrambled with the P-RNTI transmitted in the search space.

The size of the DCI for scheduling the MBS service is determined based on the type of the CSS.

Optionally, determining the size of the DCI for scheduling the MBS service further includes:
in response to the DCI for scheduling the MBS service being transmitted in a corresponding CSS, and the CSS being of Type 3, determining the size of the DCI for scheduling the MBS service as a size of payload of a second DCI format in the CSS;
in which, the second DCI format comprises at least one of: DCI format 20, DCI format 2_1, DCI format 2_2, DCI format 2_3, DCI format 2_4, DCI format 2_5, DCI format 2_6.

In a possible implementation, the type of the CSS used to transmit the MBS-specific DCI is Type3-PDCCH CSS, the terminal UE #1 and the network side perform an alignment operation on the MBS-specific DCI transmitted in the active BWP and other DCIs transmitted in the corresponding CSS, so that the sizes of the other DCIs transmitted in the CSS used to transmit the MBS-specific DCI are the same, which may be implemented according to the method described below. The specific implementation of the alignment operation is not limited in the disclosure. Considering that the DCI for scheduling the MBS service is transmitted in the Type 3 PDCCH CSS, the payload size of the DCI is consistent with the size of the DCI format 2_0, the DCI format 2_1, the DCI format 2_2, the DCI format 2_3, the DCI format 2_4, the DCI format 2_5 or the DCI format 2_6 transmitted in the search space.

Optionally, determining the size of the DCI for scheduling the MBS service further includes:
in response to the DCI for scheduling the MBS service being transmitted in a USS, determining the size of the DCI for scheduling the MBS service as a size of payload of DCI format 1_1 and/or DCI format 1_2 in the CSS.

In a possible implementation, the USS is used to transmit the MBS-specific DCI, the terminal UE #1 and the network side perform an alignment operation on the MBS-specific DCI transmitted in the active BWP and other DCIs transmitted in the corresponding USS, so that the sizes of the other DCIs transmitted in the USS used to transmit the MBS-specific DCI are the same, which may be implemented according to the method described below. The specific implementation of the alignment operation is not limited in the disclosure. Considering that the DCI for scheduling the MBS service is transmitted in the USS, the payload size of the DCI is consistent with the size of the DCI format 1_1 and/or the DCI format 1_2 transmitted in the search space.

Optionally, determining how to send the DCI for scheduling the MBS service based on the search space and the size of the DCI for scheduling the MBS service includes:
determining one or more physical downlink control channel (PDCCH) candidates within in a CSS in the active bandwidth part based on the size of the DCI for scheduling the MBS service, sending the DCI for scheduling the MBS service on all of the one or more PDCCH candidates contained in the CSS; or
determining one or more PDCCH candidates within in a CSS in the active bandwidth part based on the size of the DCI for scheduling the MBS service, sending the DCI for scheduling the MBS service on a portion of the one or more PDCCH candidates contained in the CSS.

In the embodiment of the disclosure, after obtaining the search space and the size of the DCI for scheduling the MBS service, the PDCCH candidates can be determined in the search space, the DCI for scheduling the MBS service is sent among all the PDCCH candidates according to the size of the DCI for scheduling the MBS service, and the search space is the CSS.

Or, after obtaining the search space and the size of the DCI for scheduling the MBS service, the PDCCH candidates can be determined in the search space, the DCI for scheduling the MBS service is sent among some of the PDCCH candidates according to the size of the DCI for scheduling the MBS service, and the search space is the CSS.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. An attempt of sending of the MBS-specific DCI is performed on all the PDCCH candidates included in the CSS, and the CRC of the MBS-specific DCI is scrambled with a G-RNTI.

Optionally, sending the DCI for scheduling the MBS service on the portion of the one or more PDCCH candidates contained in the CSS includes:
sending the DCI for scheduling the MBS service on N predefined PDCCH candidates, where N is a positive integer; or
sending the DCI for scheduling the MBS service on a PDCCH candidate configured and indicated by the RRC signaling.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. N PDCCH candidates are selected from the PDCCH candidates included in the CSS, an attempt of sending of the MBS-specific DCI is performed on the N PDCCH candidates, and the CRC of the MBS-specific DCI is scrambled with the G-RNTI.

In a possible implementation, the type of the CSS used to transmit the MBS-specific DCI is Type3-PDCCH CSS, and after the search space corresponding to the active BWP is determined, the DCI for scheduling the MBS service is transmitted in the search space according to a payload size (DCIpayload size) of the corresponding DCI. Some PDCCH candidates of the PDCCH candidates included in the CSS are obtained based on configuration of the RRC signaling, an attempt of sending of the MBS-specific DCI is performed on the some PDCCH candidates, and the CRC of the MBS-specific DCI is scrambled with the G-RNTI.

Optionally, determining how to send the DCI for scheduling the MBS service based on the search space and the size of the DCI for scheduling the MBS service includes:
determining one or more PDCCH candidates within in a USS in the active bandwidth part based on the size of the DCI for scheduling the MBS service, sending the DCI for scheduling the MBS service on all of the one or more PDCCH candidates contained in the USS; or
determining one or more PDCCH candidates within in a USS in the active bandwidth part based on the size of the DCI for scheduling the MBS service, sending the DCI for scheduling the MBS service on a portion of the one or more PDCCH candidates contained in the USS.

In the embodiment of the disclosure, the USS is used to transmit the MBS-specific DCI, and after the search space corresponding to the active BWP is determined, the DCI for scheduling the MBS service is transmitted in the search space according to a payload size (DCIpayload size) of the corresponding DCI. N PDCCH candidates are selected from the PDCCH candidates included in the USS, an attempt of sending of the MBS-specific DCI is performed on the N PDCCH candidates, and the CRC of the MBS-specific DCI is scrambled with the G-RNTI.

In a possible implementation, the USS is used to transmit the MBS-specific DCI, and after the search space corresponding to the active BWP is determined, the DCI for scheduling the MBS service is transmitted in the search space according to a payload size (DCIpayload size) of the corresponding DCI. Some PDCCH candidates of the PDCCH candidates included in the USS are obtained based on configuration of the RRC signaling, an attempt of sending of the MBS-specific DCI is performed on the some PDCCH candidates, and the CRC of the MBS-specific DCI is scrambled with the G-RNTI.

Optionally, sending the DCI for scheduling the MBS service on the portion of the one or more PDCCH candidates contained in the USS includes:
sending the DCI for scheduling the MBS service on N predefined PDCCH candidates, where N is a positive integer; or
sending the DCI for scheduling the MBS service on a PDCCH candidate configured and indicated by the RRC signaling.

In a possible implementation, a positive integer N is predefined, and the DCI for scheduling the MBS service is sent on the N PDCCH candidates.

In a possible implementation, a corresponding PDCCH candidate is obtained according to configuration and indication of the RRC signaling, and the DCI for scheduling the MBS service is sent on the PDCCH candidate indicated by the RRC signaling.

In the above embodiments of the disclosure, the methods according to the embodiments of the disclosure are described from the perspectives of the network device and the terminal device, respectively. In order to realize each of the functions in the methods according to the above embodiments of the disclosure, the network device and the terminal device may include a hardware structure, a software module, and realize each of the above functions in the form of hardware structure, software module, or a combination of hardware structure and software module. A certain function of the above functions may be performed in the form of hardware structure, software module, or a combination of hardware structure and software module.

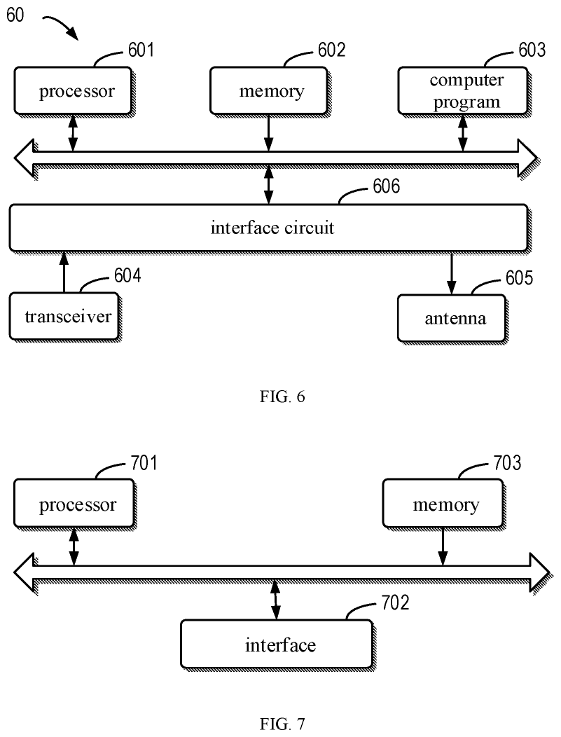

As illustrated in FIG. 5, FIG. 5 is a block diagram of a communication apparatus 50 according to an embodiment of the disclosure. The communication apparatus 50 shown in FIG. 6 may include a transceiver module 501 and a processing module 502. The transceiver module 501 may include a transmitting module and/or a receiving module. The transmitting module is configured to realize a transmitting function, and the receiving module is configured to realize a receiving function. The transceiver module 501 can realize the transmitting function and/or receiving function.

The communication apparatus 50 may be a terminal device (the terminal device as described in the foregoing method embodiments), an apparatus in the terminal device, or an apparatus capable of being used in combination with the terminal device. Or, the communication apparatus 50 may be a network device, an apparatus in the network device, or an apparatus capable of being used in combination with the network device.

The communication apparatus 50 is the terminal device, and the apparatus includes:
the processing module, configured to determine how to detect and receive DCI for scheduling a multi-broadcast scheduling (MBS) service based on a common frequency resource (CFR) configuration of a network device.

The communication apparatus 50 is the network device, and the apparatus includes:
the transmitting module, configured to send a common frequency resource (CFR) configuration to a terminal device;
the processing module, configured to determine how to send DCI for scheduling a multi-broadcast scheduling (MBS) service based on the CFR configuration.

As illustrated in FIG. 6, FIG. 6 is a block diagram of another communication apparatus 60 provided by an embodiment of the disclosure. The communication apparatus 60 may be a network device or a terminal device (such as the terminal device as described in the foregoing method embodiments), or may be a chip, a chip system or a processor that supports the network device to realize the above-described methods, or may be a chip, a chip system or a processor that supports the terminal device to realize the above-described methods. The apparatus may be used to realize the methods described in the above method embodiments with reference to the description of the above-described method embodiments.

The communication apparatus 60 may include one or more processors 601. The processor 601 may be a general purpose processor or a dedicated processor, such as, a baseband processor and a central processor. The baseband processor is used for processing communication protocols and communication data. The central processor is used for controlling the communication apparatus (e.g., a base station, a baseband chip, a terminal device, a terminal device chip, a DU, or a CU), executing computer programs, and processing data of the computer programs.

Alternatively, the communication apparatus 60 may include one or more memories 602 on which computer programs 603 may be stored. The processor 601 executes the computer programs 603 to cause the communication apparatus 60 to perform the methods described in the above method embodiments. Alternatively, the memory 602 may also store data. The communication apparatus 60 and the memory 602 may be provided separately or may be integrated together.

Alternatively, the communication apparatus 60 may also include a transceiver 604 and an antenna 605. The transceiver 604 may be referred to as a transceiver unit, a transceiver machine, or a transceiver circuit, for realizing a transceiver function. The transceiver 604 may include a receiver and a transmitter. The receiver may be referred to as a receiving machine or a receiving circuit, for realizing the receiving function. The transmitter may be referred to as a transmitter machine or a transmitting circuit, for realizing the transmitting function.

Alternatively, the communication apparatus 60 may also include one or more interface circuits 606. The interface circuits 606 are used to receive code instructions and transmit them to the processor 601. The processor 601 runs the code instructions to cause the communication apparatus 60 to perform the method described in the method embodiments.

The communication apparatus 60 is a terminal device (such as the terminal device as described in the foregoing method embodiments). The processor 601 is used to perform steps S201-S202 in FIG. 2.

The communication apparatus 60 is a network device. The transceiver 604 is used to perform step S301 in FIG. 3, and the processor 601 is used to perform step S302 in FIG. 3, and steps S401-S402 in FIG. 4.

In an implementation, the processor 601 may include a transceiver for implementing the receiving and sending functions. The transceiver may be, for example, a transceiver circuit, an interface, or an interface circuit. The transceiver circuit, the interface, or the interface circuit for implementing the receiving and sending functions may be separated or may be integrated together. The transceiver circuit, the interface, or the interface circuit described above may be used for reading and writing code/data, or may be used for signal transmission or delivery.

In an implementation, the processor 601 may store a computer program 603. When the computer program 603 runs on the processor 601, the communication apparatus 60 is caused to perform the methods described in the method embodiments above. The computer program 603 may be solidified in the processor 601, and in such case the processor 601 may be implemented by hardware.

In an implementation, the communication apparatus 60 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the description of the above embodiments may be a network device or a terminal device, but the scope of the communication apparatus described in the disclosure is not limited thereto, and the structure of the communication apparatus may not be limited by FIG. 6. The communication apparatus may be a stand-alone device or may be part of a larger device. For example, the described communication apparatus may be:
(1) a stand-alone IC, a chip, a chip system or a subsystem;
(2) a collection of ICs including one or more ICs, optionally, the collection of ICs may also include storage components for storing data and computer programs;
(3) an ASIC, such as a modem;
(4) a module that can be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

The case where the communication apparatus may be a chip or a chip system is described with reference to the schematic structure of the chip shown in FIG. 7. The chip shown in FIG. 7 includes a processor 701 and an interface 702. There may be one or more processors 701, and there may be multiple interfaces 702.

In cases where the chip is used to implement the function of the terminal device (such as the terminal device as described in the foregoing method embodiments) in the embodiment of the disclosure:

the interface 702 is used to determine how to detect and receive DCI for scheduling a multi-broadcast scheduling (NBS) service based on a CFR configuration of a network device.

In cases where the chip is used to implement the function of the network device in the embodiment of the disclosure:
the interface 702 is configured to send a common frequency resource (CFR) configuration to a the terminal device; and determine how to send DCI for scheduling a multi-broadcast scheduling (MBS) service based on the CFR configuration.

Alternatively, the chip further includes a memory 703 used to store necessary computer programs and data.

It is understood by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be understood as beyond the scope of protection of the embodiments of the disclosure.

The embodiments of the disclosure also provide a system for transmitting DCI. The system includes a communication apparatus acting as a terminal device (such as the terminal device as described in the foregoing method embodiments) and a communication apparatus acting as a network device, or the system includes a communication apparatus acting as a terminal device (such as the terminal device as described in the foregoing method embodiments) and a communication apparatus acting as a network device in the preceding embodiment of FIG. 6.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, the above embodiments may be implemented, in whole or in part, in the form of a computer program product. The computer program product includes one or more computer programs. When loading and executing the computer program on the computer, all or part of processes or functions described in the embodiments of the disclosure is implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., using coaxial cables, fiber optics, or digital subscriber lines (DSLs) or wireless manner (e.g., using infrared wave, wireless wave, or microwave). The computer-readable storage medium may be any usable medium to which the computer is capable to access or a data storage device such as a server integrated by one or more usable mediums and a data center. The usable medium may be a magnetic medium (e.g., a floppy disk, a hard disk, and a tape), an optical medium (e.g., a high-density digital video disc (DVD)), or a semiconductor medium (e.g., a solid state disk (SSD)).

Those skilled in the art can understand that the first, second, and other various numerical numbers involved in the disclosure are only described for the convenience of differentiation, and are not used to limit the scope of the embodiments of the disclosure, or used to indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that can be understood by the communication apparatus, and the values or representations of the parameters may be other values or representations that can be understood by the communication apparatus. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, define in advance, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above can be referred to the corresponding processes in the preceding method embodiments, and will not be repeated herein.

The above are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the appended claims.

1. A method for transmitting downlink control information (DCI), performed by a terminal device, comprising:
determining how to detect and receive DCI for scheduling a multi-broadcast scheduling (MBS) service based on a common frequency resource (CFR) configuration of a network device.

2. The method of claim 1, wherein determining how to detect and receive the DCI for scheduling the MBS service based on the CFR configuration of the network device comprises:
detecting and receiving the DCI for scheduling the MBS service based on the CFR configuration, wherein the CFR configuration is received from the network device, and the CFR configuration comprising a control resource set (CORESET) or a search space.

3. The method of claim 1, wherein determining how to detect and receive the DCI for scheduling the MBS service based on the CFR configuration of the network device comprises:
determining how to detect and receive the DCI for scheduling the MBS service based on a predetermined mode or a radio resource control (RRC) signaling, wherein the CFR configuration is not received from the network device, or wherein the CFR configuration is received from the network device but the CFR configuration having no corresponding search space configuration and a CORESET for a non-MBS data transmission is completely contained in the CFR configuration.

4. The method of claim 3, wherein determining how to detect and receive the DCI for scheduling the MBS service based on the predetermined mode comprises:
determining a search space within an active bandwidth part, and determining a size of the DCI for scheduling the MBS service; and
determining how to detect and receive the DCI for scheduling the MBS service based on the search space and the size of the DCI for scheduling the MBS service.

5. The method of claim 4, wherein determining the search space within the active bandwidth part comprises:
determining the search space based on a common search space (CSS) configured in a bandwidth part, wherein the network device configures an MBS terminal group.

6-7. (canceled)

8. The method of claim 4, wherein determining the search space within the active bandwidth part further comprises:
determining the search space based on a UE-specific search space (USS) configured in a bandwidth part, wherein the network device configures an MBS terminal group.

9-10. (canceled)

11. The method of claim 4, wherein determining how to detect and receive the DCI for scheduling the MBS service based on the RRC signaling comprises: determining the search space within the active bandwidth part based on a search space number in the RRC signaling.

12. The method of claim 4, wherein determining the size of the DCI for scheduling the MBS service comprises:
determining the size of the DCI for scheduling the MBS service as a size of payload of a first DCI format in a corresponding CSS, wherein the DCI for scheduling the MBS service is transmitted in the CSS, and the CSS is of Type 0/0a/1/2; wherein, the first DCI format comprises at least one of: DCI format 1_0 scrambled with a system information radio network temporary identifier (SI-RNTI), DCI format 1_0 scrambled with a random access radio network temporary identifier (RA-RNTI), DCI format 1_0 scrambled with a temporary cell radio network temporary identifier (TC-RNTI), and DCI format 1_0 scrambled with a paging radio network temporary identifier (P-RNTI).

13. The method of claim 4, wherein determining the size of the DCI for scheduling the MBS service further comprises:
determining the size of the DCI for scheduling the MBS service as a size of payload of a second DCI format in a corresponding CSS, wherein the DCI for scheduling the MBS service is transmitted in the CSS, and the CSS is of Type 3; wherein, the second DCI format comprises at least one of: DCI format 2_0, DCI format 2_1, DCI format 2_2, DCI format 23, DCI format 2_4, DCI format 2_5, DCI format 2_6.

14. The method of claim 4, wherein determining the size of the DCI for scheduling the MBS service further comprises:
determining the size of the DCI for scheduling the MBS service as a size of payload of DCI format 1_1 and/or DCI format 1_2 in a USS, wherein the DCI for scheduling the MBS service is transmitted in the USS.

15. The method of claim 4, wherein determining how to detect and receive the DCI for scheduling the MBS service based on the search space and the size of the DCI for scheduling the MBS service comprises one of the following:
determining one or more physical downlink control channel (PDCCH) candidates within in a CSS in the active bandwidth part based on the size of the DCI for scheduling the MBS service, detecting and receiving the DCI for scheduling the MBS service on all of the one or more PDCCH candidates contained in the CSS; or
determining one or more PDCCH candidates within in a CSS in the active bandwidth part based on the size of the DCI for scheduling the MBS service, detecting and receiving the DCI for scheduling the MBS service on a portion of the one or more PDCCH candidates contained in the CSS.

16. The method of claim 15, wherein detecting and receiving the DCI for scheduling the MBS service on the portion of the one or more PDCCH candidates contained in the CSS comprises one of the following:
detecting and receiving the DCI for scheduling the MBS service on N predefined PDCCH candidates, where N is a positive integer; or
detecting and receiving the DCI for scheduling the MBS service on a PDCCH candidate configured and indicated by the RRC signaling.

17. The method of claim 4, wherein determining how to detect and receive the DCI for scheduling the MBS service based on the search space and the size of the DCI for scheduling the MBS service comprises one of the following:
determining one or more PDCCH candidates within in a USS in the active bandwidth part based on the size of the DCI for scheduling the MBS service, detecting and receiving the DCI for scheduling the MBS service on all of the one or more PDCCH candidates contained in the USS; or
determining one or more PDCCH candidates within in a USS in the active bandwidth part based on the size of the DCI for scheduling the MBS service, detecting and receiving the DCI for scheduling the MBS service on a portion of the one or more PDCCH candidates contained in the USS.

18. (canceled)

19. A method for transmitting downlink control information (DCI), performed by a network device, comprising:
determining how to send DCI for scheduling a multi-broadcast scheduling (MBS) service based on a common frequency resource (CFR) configuration.

20. The method of claim 19, the method further comprises:
sending the CFR configuration to a terminal device; and
wherein determining how to send the DCI for scheduling the MBS service based on the CFR configuration comprises:
sending the DCI for scheduling the MBS service based on the CFR configuration, wherein the CFR configuration comprises a control resource set (CORESET) or a search space.

21. The method of claim 19, wherein determining how to send the DCI for scheduling the MBS service based on the CFR configuration comprises:
determining how to send the DCI for scheduling the MBS service based on a predetermined mode or a radio resource control (RRC) signaling, wherein no CFR is configured, or wherein the CFR configuration has no corresponding search space configuration- and a CORESET for a non-MBS data transmission is completely contained in the CFR configuration.

22. The method of claim 21, wherein determining how to send the DCI for scheduling the MBS service based on the predetermined mode comprises:
determining a search space within an active bandwidth part, and determining a size of the DCI for scheduling the MBS service; and
determining how to send the DCI for scheduling the MBS service based on the search space and the size of the DCI for scheduling the MBS service.

23. The method of claim 22, wherein determining the search space within the active bandwidth part comprises:
determining the search space based on a common search space (CSS) configured in a bandwidth part, wherein an MBS terminal group is configured and the terminal device belongs to the MBS terminal group.

24-38. (canceled)

39. A terminal device, comprising a processor and a memory, wherein a computer program is stored in the memory, and the processor executes the computer program stored in the memory, to cause the terminal device to perform;
determining how to detect and receive DCI for scheduling a multi-broadcast scheduling (MBS) service based on a common frequency resource (CFR) configuration of a network device.

40. A network device, comprising a processor and a memory, wherein a computer program is stored in the memory, and the processor executes the computer program stored in the memory, to cause the network device to perform the method of claim 19.

41-44. (canceled)
